(19) United States
(12) Patent Application Publication
(10) Pub. No.: US 2006/0215936 A1
(43) Pub. Date: Sep. 28, 2006

(54) Systems and methods for the dissemination of content by a network using a facsimile machine

(76) Inventors: Barnaby Dorfman, Palo Alto, CA (US); John Hjelmstad, Palo Alto, CA (US); Jonathan Leblang, Menlo Park, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/090,926

(22) Filed: Mar. 25, 2005

(51) Int. Cl. G06K 9/54

(52) U.S. Cl. 382/306

(57) ABSTRACT

A system and methods are provided for extracting content from a facsimile transmission, and providing the content to a web site or other content dissemination system. One embodiment provides the content in accordance with control information included in the facsimile transmission. In one embodiment, the system and methods permit originator-users, such as users that otherwise lack resources to create web pages, to conveniently and inexpensively provide content for a web site using a conventional facsimile machine.

### BACKGROUND

1. Field of the Invention

The invention generally relates to automated techniques for making content available on a web site, or other electronic repository, using a facsimile machine.

2. Description of the Related Art

The Internet and the World Wide Web provide a highly efficient and effective mechanism for individuals, businesses, and other types of entities to disseminate information. For example, businesses commonly set up web sites to disseminate information about the products and services they offer. Information about specific entities is also commonly published via online directories, such as online “yellow pages” web sites.

Despite the significant benefits of having a World Wide Web presence, many entities fail to disseminate information via web sites due to a lack of resources. This is particularly true for small businesses, such as restaurants, convenience stores, gas stations, and laundry services, that do not have Internet access and/or do not have the skills needed to create web pages and/or other forms of electronic documents.

### SUMMARY

The present invention provides a system and associated methods for making content available, such as web site content, using a facsimile machine. For example, originator-users that are providing content can use a control form that may be electronically communicated to a designated facsimile number to provide associated content to a web site. The control form includes a content section for providing textual and/or graphical content to be made publicly available in an associated electronic document, and a control section for providing associated control information for the document. The control section may, for example, include a bar code or other representation of a unique identifier associated with the particular content provider or originator-user, which can in turn be associated with a web site or a corresponding electronic repository for the web site. Bubbles and/or other types of optical mark recognition characters may also be provided for permitting the content provider to, for example, specify the type or types of content being provided, and/or to specify where, when, how, how long, and the like, the corresponding content is to be displayed in the document. It will be understood that many variations for identifying a particular web site for association with the document exist.

Upon receiving a facsimile transmission of a completed form, the system extracts the content, and provides the content to a content database in accordance with the control information. For example, the system may store the extracted content in a database record, or in a web page document, associated with the originator-user. The data provided to the content database may be statically or dynamically incorporated into pages of one or more web sites.

In one embodiment, an image of a physical form with a machine-readable control portion is received. Corresponding content can be optionally provided, can be provided later, or can already be present. The machine-readable control portion is processed to extract the corresponding control information, and the corresponding content is programmatically altered in accordance with the control information. For example, the control information can indicate that the corresponding content is to be displayed at a web site. In another example, the control information can indicate that the corresponding content can be sent to a user via an electronic message, such as an email message.

One aspect of the invention is thus a computer-implemented method of making content available on a web site. The method comprises receiving a facsimile transmission of a form that includes a content portion comprising content to be made available to a web site. The form also includes a machine-readable control portion that includes control information associated with the content. The method additionally comprises storing a digital representation of the facsimile transmission in computer storage; processing the digital representation of the facsimile transmission to extract the content and the associated control information; and programmatically making the content available in accordance with the control information to a user of the web site. The control portion may include, for example, a bar code representation of a unique identifier, which may be used by the system to associate a web page to which the content is to be made available or a corresponding database record thereof. In other examples, the content is provided by the content provider without a control form, and the corresponding database record or web page for making the content publicly available is associated using other techniques, such as, but not limited to, caller ID, key exchange, and others.

In another embodiment, a facsimile transmission of a form is received in one or more computer systems. At least a portion of the facsimile transmission is processed to create a displayable content item. A source of the facsimile transmission is determined using at least one of a telephone service feature or a transmitting subscriber identification (TSI) number, and the identified source is associated with the displayable content item in a database record. The displayable content item can then be communicated to users via Web sites, email messages, and the like.

Neither this summary nor the following detailed description purports to define the invention. The invention is defined by the claims.

### BRIEF DESCRIPTION OF THE DRAWINGS

Specific embodiments of the invention will now be described with reference to the drawings summarized below.

FIG. 1 illustrates a networked system with a content association system.

FIG. 2 illustrates a process performed by the content association system.

FIG. 3A illustrates an example of a control form for a sender or originator of a facsimile transmission to control at least one aspect of a content association system.

FIG. 3B illustrates another example of a control form.

FIG. 3C illustrates an example of a form without an identifier.

FIG. 4 illustrates an example of a screenshot of a web page using the content association system.

### DETAILED DESCRIPTION OF SPECIFIC EMBODIMENTS

Although particular embodiments of the invention are described herein, other embodiments, including embodiments that do not provide all of the benefits and features set forth herein, will be apparent to those of ordinary skill in the art, and are included within the scope of the invention. For example, although disclosed in the context of web content, the invention may also be used to provide other types of network content.

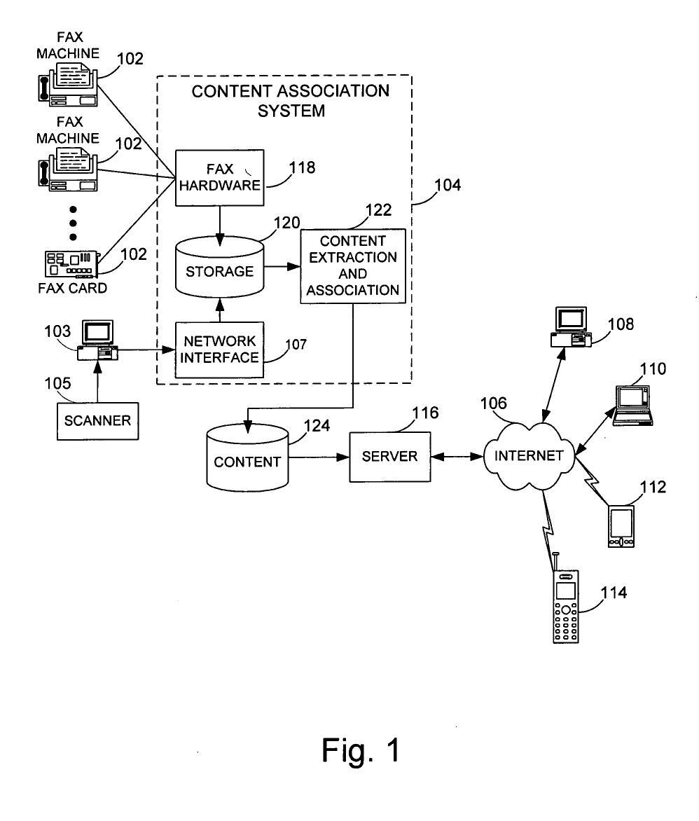

FIG. 1 illustrates a networked system that includes a content association system 104. In the illustrated embodiment, the content association system 104 automatically makes content from electronic transmissions, such as facsimile transmissions, available in one or more web sites or other forms of electronic communication, such as email. The system 104 may, for example, be used by small businesses to make content available in an online business directory (e.g., a “yellow pages” web site), and/or to make content available to their own web sites. For instance, a Chinese restaurant may use the system to publish its menu, coupons, business hours, job listings, etc., in textual and/or graphic form, to an online directory or to one or more specific web pages.

The content association system 104 includes facsimile (fax) modem hardware 118, which is coupled to one or more phone lines. The fax modem hardware 118 permits the content association system 104 to receive fax transmissions. The content association system 104 receives the fax transmissions from fax machines 102, which are operated by an originator-user. The fax machines 102 may be conventional fax machines that comply, for example, with one or more of the following standards from the International Telecommunication Union (ITU): the Group 1 facsimile standard, as described in ITU-T recommendation T.2; the Group 2 facsimile standard, as described in recommendation T.3; and/or the Group 3 facsimile standard, as described in recommendation T.4. The fax machines 102 can also include computer systems with fax cards, fax modems, and the like, which are capable of sending a facsimile transmission. It will be understood that where fax cards or fax modems are used, sheets to be faxed can be scanned in first before being faxed. The Group 3 facsimile standard is currently in widespread use. The content association system 104 may also support other facsimile standards and specifications, such as the ITU-T30E color fax standard, and/or standards that are developed in the future.

In one embodiment, the fax modem hardware 118 is also compatible with a facsimile transmission from a fax machine 102 that does not correspond to a fax standard, such as, for example, receiving a file in TIFF or PDF format that is scanned in by the fax machine 102 and sent to the fax modem hardware 118 by a modem protocol or scanned in by a scanner 105. One embodiment of the content association system 104 includes a network interface 107 for receiving scanned images of physical forms. These scanned images can include content and/or control information. For example, the network interface 107 can be in communication with a personal computer 103 with a scanner 105, and can use a network such as the Internet. The personal computer 103 can provide the scanned image in any of a wide variety of formats, such as, but not limited to, PDF, BMP, JPG, GIF, and the like. It will be understood that a wide variety of devices, such as a copy machine with a scanner interface, can also be used.

Originator-users of the fax machines 102 fax documents to one or more telephone numbers associated with the content association system 104. Each fax document includes a content portion and a control portion. The content portion includes textual and/or graphical content to be made publicly available. The control portion includes control information that specifies how, where, when, and/or how long the content is to be made available. The content portion and the control portion can be included on the same page, or, in the case of multi-page fax transmissions, on separate pages. In the case of multi-page transmissions, the control portion can be spread across multiple pages, or repeated on one or more pages to provide redundancy. In another example, only one of a control portion or a content portion is provided and stored and/or acted on by the content association system 104.

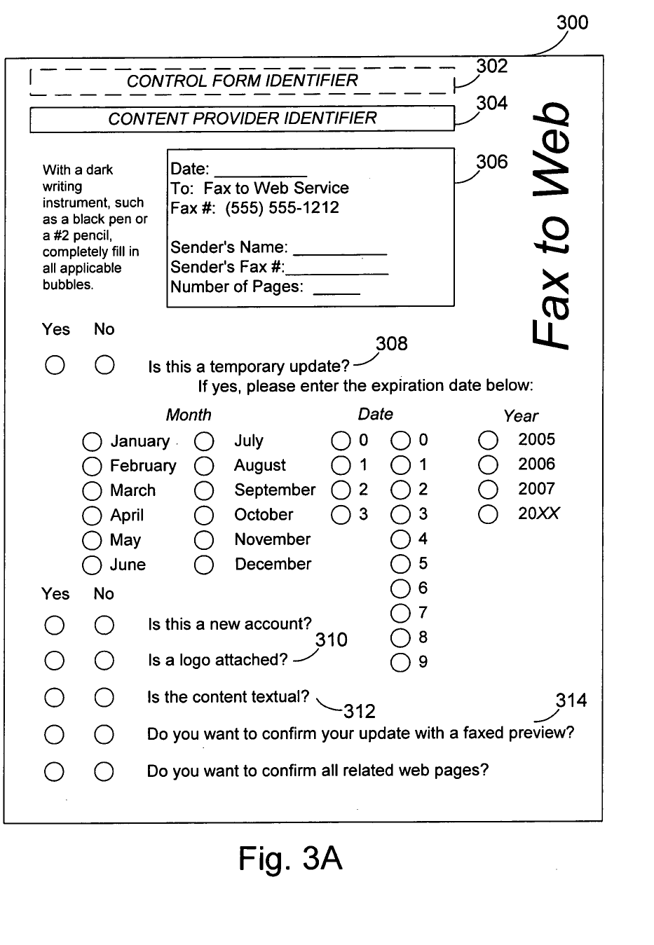

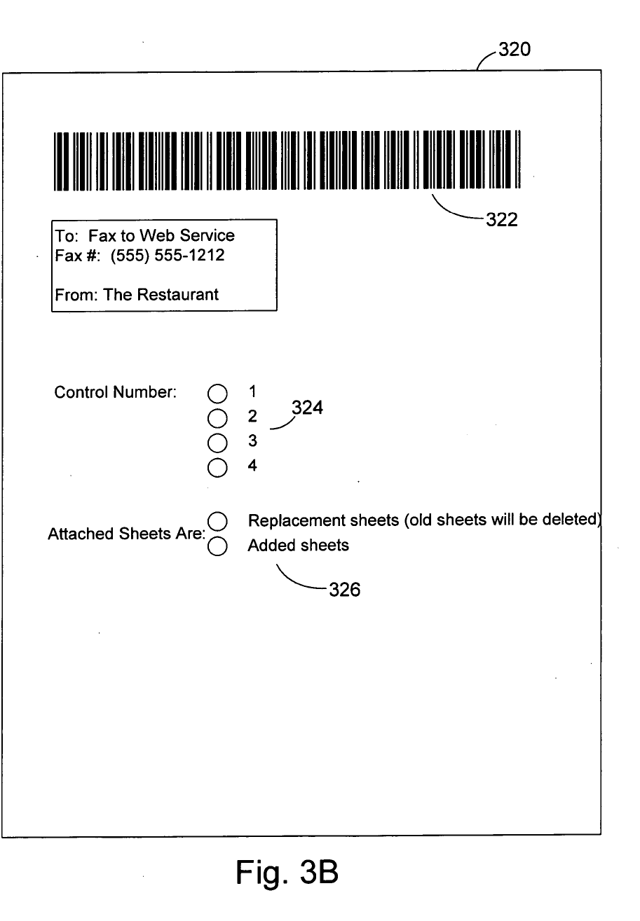

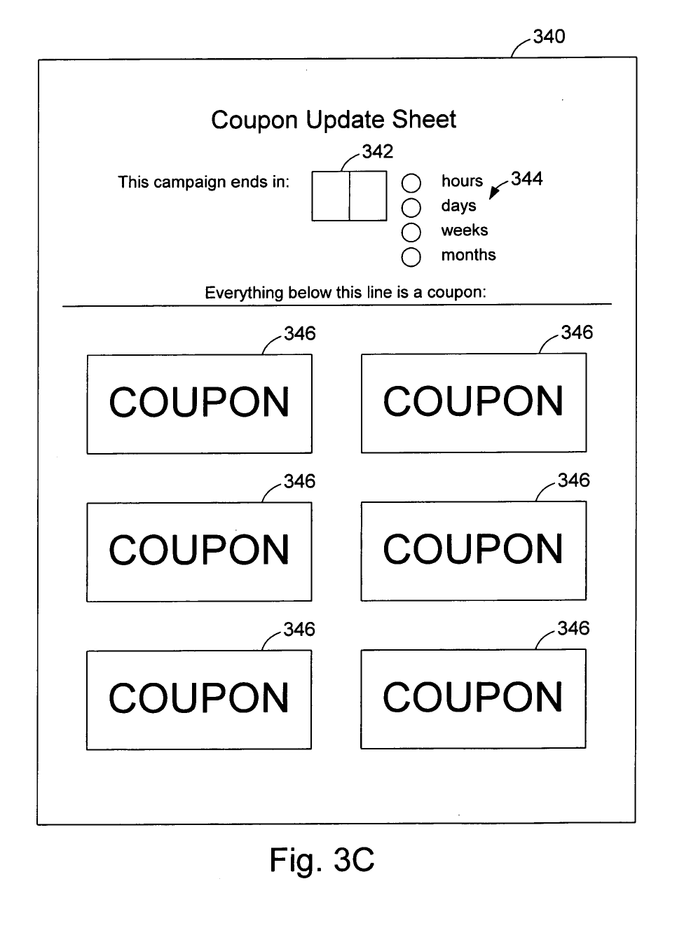

In one embodiment, the control portion includes a bar code label, or other machine-readable marking, that includes a unique identifier. An example of a control sheet with a control portion is described below in connection with FIG. 3A. The unique identifier can be associated directly or indirectly with the originator-user of the document or an electronic address for an electronic repository, such as a web address for a web site, where the content is to be made publicly available. Different identifiers may be assigned to different entities providing content to the content association system 104. The identifier may, for example, be a unique identifier of a particular business, or other entity, that has established an account with the system 104. In addition, identifiers may be assigned and disseminated to entities that do not yet have accounts with the system 104, but which may be interested in providing content.

A data store 120 stores a digital representation of each received facsimile transmission or other communication of an image. The data store 120 can be implemented using any one or more types of storage devices such as solid state memories and disk drives. Each fax transmission or other data transmission is stored as a separate electronic document in a file system, although other types of data structures and repositories may additionally or alternatively be used. In the illustrated embodiment, the data store 120 is also in communication with the network interface 107 to store received scanned image.

Each electronic document stored in the data store 120 is processed by a “content extraction and association” component 122, which may be implemented within software executed by a general purpose computer. The content extraction and association component 122 generally operates by extracting the content and control portions of each received fax document or other electronic document (either in real time as it is received or at a later time), and by providing the extracted content to a content repository 124 in accordance with the control information included in the control portion. Examples of control portions of a document will be described later in connection with FIG. 3A.

The content repository 124 may, for example, be a file system, a database, or a collection of file systems and/or databases. In one embodiment, the content portion of each received fax document is stored in the content repository 124 in association with the unique identifier provided in the control portion. In one embodiment, the content repository 124 corresponds to a repository for web content. In the case of static pages, the content extraction and association component 122 may alternatively use the identifier to select a web page, or set of web pages, to be created or updated. Web content may also enter the content repository 124 from other sources.

The content stored in the content repository 124 can be made available on the Internet 106 via one or more servers 116, one of which is shown. The server 116 may host a single web site or multiple web sites. If multiple web sites are provided, the identity of the web site to which a given piece of content is to be made available may depend on the associated identifier. Although illustrated as a server 116 in FIG. 1, the content may be disseminated using another type of document and document server. Examples of other types of electronic documents include word processing files such as Microsoft® Word® documents, platform-independent files such as Adobe® Portable Document Format documents, graphical image files, and the like. The available content may additionally or alternatively be disseminated to various web sites via RSS (Rich Site Summary) feeds, or using another type of syndication process.

One application for the content association system 104 is to enable business entities to provide content to a web-based business directory or “yellow pages,” which may be hosted by a particular web site. In one example, each business entity that provides content is provided with a form that includes a unique identifier of the business. This form may be completed by the respective business and faxed to the content association system 104, to create and/or update a corresponding business listing. Other forms of communication, such as the scanning of an electronic document and the electronic sending of the scanned document can also apply. Different types of forms may be provided for different functions, e.g., creating a new listing, updating an existing listing, uploading a logo, etc. Another example of an application of the content association system 104 is to enable sellers in an online marketplace, such as an online auction system or a fixed-price sales system, to provide sales listings for the online marketplace using a fax machine. In both of these applications (business directories and online marketplaces), all of the fax-based listings may be displayed on a common web site, or may be spread across multiple web sites. Yet another application of the content association system 104 is to allow users to send email messages via their respective fax machines 102 to recipients without the inconvenience of having to directly address the designated recipients or even know the recipients' email addresses.

The content provided via the system 104 may be accessed over the Internet 106 using a variety of different types of user computing devices. As shown in FIG. 1, these devices include, but are not limited to, personal computers (PCs) 108, laptop computers 110, personal digital assistants (PDAs) 112, and web-enabled cellular telephones 114. Other types of devices, such as web-enabled televisions, Pocket PCs, wireless email devices, and Smartphones, can also be used. Each computing device 108, 110, 112, 114 executes client software, such as a web browser (e.g., Microsoft® Internet Explorer), and/or a proprietary document reader (e.g., Adobe® Acrobat®), that is capable of requesting and displaying the content hosted by the server 116.

If dynamically-generated web pages are used, the server 116 may generate web pages in real time in response to page requests from the recipient-user computing devices. In such cases, web page templates may be used to generate web pages from content, including the fax-based content, stored in the web content repository. For instance, when a recipient-user requests the business listing of a particular business, content extracted from one or more fax documents sent in by the business may be used to dynamically build a corresponding web page/listing.

The content association system 104 may be implemented using one or more general-purpose computers configured to receive and process facsimile transmissions. Typically, the content association system 104 and the server 116 will be implemented on separate computers, although a common computer can be used to implement both.

Example Server Process

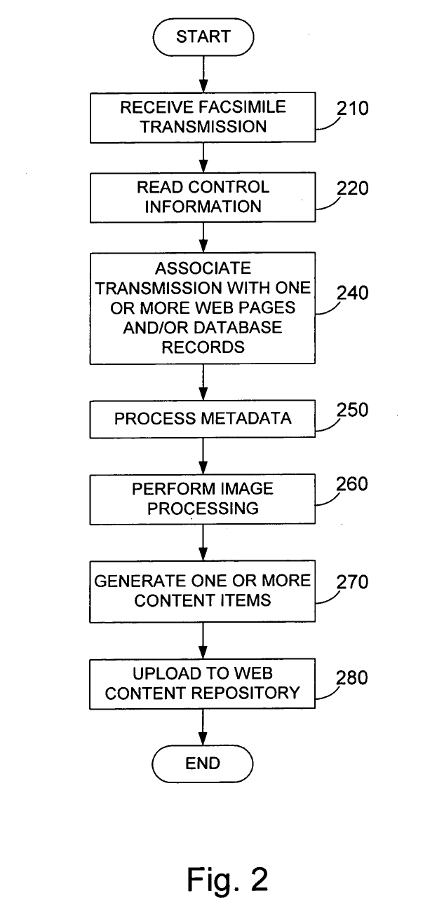

FIG. 2 illustrates an example of an automated process that can be performed by the content association system 104 to process an incoming fax transmission. While illustrated generally in the context of a facsimile transmission, it will be understood that the process can apply to other electronic communications of images of forms, such as the transfer of files for scanned images via a network. In addition, the process will be described in the context of a facsimile transmission having both control information and content. It will be understood that the illustrated process will also be applicable to an electronic communication having one of the control information or content. It will be appreciated by the skilled practitioner that the illustrated process can be modified in a variety of ways. For example, in another embodiment, various portions of the illustrated process can be combined, can be rearranged in an alternate sequence, can be removed, and the like. In addition, it will be understood that additional features can be added to the illustrated process. The process may be embodied within executable software executed by one or more general-purpose computers.

The process begins by receiving 210 a facsimile transmission. For example, one or more fax modems and a fax server can be used to receive 210 the facsimile transmission. The received fax transmission is stored in the storage 120. Other information about the facsimile transmission, such as the length of the transmission, the time and date it was received, and the like, can also be stored.

Where applicable, the process then proceeds to read 220 control information, including an optional identifier, included in a fax document. For example, the identifier may be a unique identifier of originator-user, such as a business or an individual, that is sending the facsimile transmission. The unique identifier can be used in associating the facsimile transmission with the originator-user or corresponding database record as will be explained in a block 240. In another embodiment, the identifier can correspond to an electronic resource address for the content. Depending upon how the identifier and other control information is provided within the document, the control information may be read using optical character recognition (OCR), optical mark recognition (OMR), and/or other techniques. Examples of optical marks include barcodes, fill-in bubbles, and checkboxes. These and other optical marks will be described later in connection with the control form illustrated in FIG. 3A. The optical character recognition (OCR) and optical mark recognition (OMR) functionality, if provided, may be embodied within one or more executable software modules of the content extraction and association component 122. In one example, the control information corresponds to HTML tags that are read and interpreted by the process.

The process associates 240 the facsimile transmission with one or more web pages, and/or with one or more database records. For example, the transmission may be associated with a database record uniquely associated with the extracted identifier, in which case the content extracted from the transmission may be used to update this record. As another example, the unique identifier can be mapped to a URI of a resource in an information space, such as the URL of a web page or other object, that is to be updated with the content. In some cases, a new database record, and/or a new web page, may be created in response to the transmission. It will be understood that other techniques can be used to identify the originator-user and associate the facsimile transmission with the appropriate database records. For example, these other techniques can include recognition of a calling phone number (such as Caller ID and automatic number identification), transmitting subscriber information (TSI) from a facsimile machine, an originating email address, an originating Internet Protocol address (IP address), and the like.

As depicted by block 250, the process proceeds to process the extracted control information, referred to herein as metadata, that provides information about the content portion of the facsimile transmission. Metadata, as used herein, includes some indication of control parameters for content, such as processing of content, conversion of content from one format to another, placement of content within an electronic document, a temporal availability of the content, or the like. For example, information on the control form may indicate the type of information contained in the facsimile transmission (e.g., text, graphics, a logo, coupons or other promotions, temporal constraints such as expiration dates, length of time, etc.). This metadata, when available, may be used as a control parameter to extract and interpret the content, to determine how to present such content on one or more web pages, and/or to determine how long such content is to remain valid. For instance, content designated by the control information as textual may automatically be converted to text using OCR, while content designated as graphical may be maintained in a graphical form, such as in a bitmap form.

The process then proceeds to perform image processing 260 on the content portion of the facsimile transmission. One example of image processing includes scaling of an image, such as the scaling (larger or smaller) of a logo, to improve its appearance. In one embodiment, where the facsimile transmission of a half-toned image is detected, the process automatically processes the half-toned image to a grayscale image by, for example, an interpolation process. This process automatically converts the bi-tonal quality of a typical Group 3 fax, which is useful for printing, to grayscale, which is typically more suitable for display.

Another example is the processing of a fax image to a file format for inclusion in a web page that is viewable in a web browser, such as conversion to a GIF file, a JPEG file, and the like. In one embodiment, non-halftoned faxes are encoded by GIF and half-toned images are converted to grayscale and encoded in JPEG. It should be noted that while the faxed content portion of a Group 3 fax transmission cannot be transmitted in color, a color can be associated with the faxed content portion, and portions of a web page corresponding to the content portion can be processed to a specified color. For example, black portions of the content portion can be changed to color specified in the embedded control information.

The image processing 260 may include conversion to text of at least a portion of the facsimile transmission. An optical character recognition (OCR) process can be used to detect text in a graphical image. This may, for example, be performed in response to a determination that the facsimile transmission corresponds to text, or in response to reading an indication, such as an optical mark filled in by the originator-user, instructing the content association system 104 to convert the contents of the facsimile transmission to textual data. In one embodiment, the OCR process is used to generate text for word searches to permit a recipient user to find the electronic document using a keyword search, to permit recipient-users to be notified of matches with keywords in a watch list, and the like.

The illustrated process proceeds to generate 270 one or more content items or objects to be stored in the content repository 124. Each content item may, for example, be in the form of text, a graphic, or any other appropriate type of content. For example, an appropriate file format can be selected for the content item. A wide variety of file formats may be applicable, such as markup language formats, e.g., hypertext markup language (HTML), extensible hypertext markup language (XHTML), scalable vector language (SVL), and the like, as well as graphical formats, word processing formats, and the like.

Accordingly to the selected file format, the desired appearance of the corresponding electronic document can be generated by, for example, defining visual features such as headers, tables, cells, and the like. A common template can be used for related content items. In addition, where web pages are generated, a cascading style sheet (CSS) can be used to specify the presentation of the document. Where the content item is a separate document, it will be understood that the appropriate headers and file extensions should be used so that the document is readily associated with the appropriate application for viewing. Where the content item is incorporated in another document, an appropriate tag including a wrapper can assist the viewing application to understand how to display the content item. It will also be understood that rather than incorporate the content item into another electronic document, the electronic document can include a reference or anchor to the content item as a link target. Related documents, such as associated web pages, such as web pages of the business entity or web pages in a “yellow pages” directory, can also be updated with references to the new content.

The content item can be used by a server process to dynamically generate web pages with faxed content portions. One embodiment uses an active server page (ASP) to dynamically generate a web page. These ASPs can be written in a variety of scripting languages, such as JavaScript, VBScript, Perl, and the like. An otherwise static web page can also be supplemented with a web feed, such as an XML, an RSS, an Atom web feed, and the like, that provides dynamic data. In one embodiment, the process generates 270 an entire web page or set of web pages where static web pages are desired.

The process proceeds to upload 280 the content item to the content repository 124. In the case of static web pages, this may task may include updating one or more static pages (e.g., HTML documents) with one or more of the generated content items. In the case of dynamically generated pages, the content items may be added to a database record associated with the unique identifier. A server can send a message including the content to a recipient user, can provide an electronic document including the content to a recipient user in response to a request for the electronic document, and the like.

Authentication

The process can also optionally include authentication protection to protect against unauthorized dissemination of content. For example, the optical marks or optical characters used to identify the originator can be encrypted or otherwise rendered not readily intelligible to a human in order to provide a layer of security to prevent gaming or spoofing of the entity. For example, a relatively long string of pseudo-random alphabetic characters, numerals, alphanumeric characters, and/or other symbols, can be used as the identifier. In another example, where a computer with a scanner uploads an image of a control form to the content association system 104, authentication is provided by key exchange between the computer and the content association system 104.

Other techniques can additionally or alternatively be used to authenticate the facsimile transmission. For example, a telephone service feature such as caller ID can be used to receive the sending or calling fax telephone number, which can be used to identify or authenticate the originator. Another example of a telephone service feature providing the calling telephone number is automatic number identification (ANI). In another example, a transmitting subscriber identification (TSI) number that is provided by the fax machine is used to authenticate the facsimile transmission. The received information, such as the calling telephone number, can be used as a key in a database to associate the corresponding facsimile transmission with an account, record, web site, recipient list, or the like, associated with the calling telephone number or originator-user. In another example, an encryption key, an IP address or the like can be used as a key in a database to associate an image transferred from a computer of an originator-user.

Web Page Previews

The process can also optionally generate a preview of the web page and permit the originator to approve the web page prior to making the web page available on the web site. In one example, a return fax illustrating a preview of the web page is generated and sent to the originator's fax machine 102. The return fax can include one or more additional control forms that can be returned to the content association system 104 to indicate whether the web page is approved for publication. In one example, if no control form is returned, the content association system uses a default rule to determine whether to publish the web page. In another example, the originator can approve the web page by dialing a phone number provided on the control form and interfacing with a touch-tone telephone menu and/or entering a control number printed on the control form. In another example, an approval email can be sent with a reply email address or a unique URI. For example, a visit to the unique URI can serve to approve the web page. In one embodiment, a default rule uses an expiration of a passage of time without receiving contrary instructions as an indication that the web page is approved for publishing. Other techniques will be readily apparent to one of ordinary skill in the art.

Optional Preview Processing

Where the web page includes colors or shades of gray, one embodiment further converts the preview of the web page to a half-toned image and sends the half-toned rendition of the web page to the originator's fax for a clearer facsimile transmission. If the originator's fax is compatible with color, it will be understood that the preview can be sent in color.

In one embodiment, the process determines that the originator has sent graphical image data that may be better captured using a half-toning mode rather than a standard text mode for the facsimile transmission. For example, the process can detect that a received image is substantially black or has relatively large areas that are substantially black. This can occur with a standard text mode when a shaded or colored area is dark enough to be above the threshold used by the fax machine to be encoded as a black pixel. For example, with a standard fax mode, images with a background or text printed on colored paper, such as a menu, can be transmitted as nearly all black images. In one embodiment, when the process determines that this problem has likely occurred, the process automatically generates an informative message included in the confirmation message instructing the originator of the facsimile transmission that a half-toning mode may be available on the originator's fax machine and that a better image will typically result.

In one embodiment, the process optionally performs an OCR process on at least a portion of the facsimile transmission and uses the extracted text as a content portion of a web page. The process can monitor a text conversion error rate of the OCR process. When the error rate of the OCR is determined to be relatively high, the process can request the originator to resend the facsimile transmission using a higher resolution fax mode or using a halftone mode. For example, a standard facsimile resolution is about 203 horizontal dots per inch and 98 vertical dots per inch. A high fax resolution is about 203 horizontal dots per inch and 196 vertical dots per inch. It will be understood that other fax resolution modes may be available.

Control Form Example

FIG. 3A illustrates an example of a control form 300 that may be completed by an originator-user, and faxed to a designated number, to making corresponding content available on a web site. The form 300 may be completed using a pencil or pen, or may be editable and printable via a computer. The content to be published may be provided on separate pages in this example.

The control form 300 can be provided to the originator of the fax in a wide variety of ways. For example, the control form 300 can be downloaded and printed from a web site; can be emailed and printed; can be emailed to the originator-user in response to an email sent by the originator-user to a specified email address, can be faxed to the originator-user; or can be sent by postal mail to the originator by itself, with a shipment of goods as an insert, or the like. In one embodiment, a portion of the control form 300 is provided as a machine-readable sticker that is applied to a sheet of paper and converts the sheet of paper into the control form 300. In one embodiment, a shipping address for a shipment of goods from a vendor, such as an online vendor, is recognized as a business address, a control form 300 customized for the business is included as an insert to the package. For example, the control form 300 can be customized to include pre-printed identifiers that are associated with the business.

The illustrated control form 300 includes to machine-readable control information. The machine-readable control portion can correspond to machine-readable characters or marks and are used as machine instructions to control the extraction of content, and/or the incorporation of such content into one or more electronic documents. In one embodiment, the control form 300 corresponds to a fax cover sheet. However, it will be understood that the control form 300 can include multiple pages and does not need to be the first sheet of a facsimile transmission. In addition, it should be noted that the type of information that can be provided on the control form 300 can vary widely, and that the illustrated control form 300 is but one example. Other variations will be readily apparent to those of ordinary skill in the art. A variety of different control forms may be provided to the originator, each of which corresponds to a different type of content and/or function.

The illustrated control form 300 in this example, includes an optional control form identifier 302 and an optional content provider identifier 304. The optional control form identifier 302 and the optional content provider identifier 304 correspond to machine-generated characters and/or optical marks that can be facsimile transmitted and machine read with a relatively low error rate. There are many examples of optical marks, including one-dimensional and two-dimensional bar codes. Fill-in bubbles can also be used as optical marks for optical mark recognition (OMR). In another embodiment, characters that can be recognized by optical character recognition (OCR) techniques are used for the identifiers 302, 304. Error detection codes and/or error correction codes may be included with the identifiers 302, 304 to reduce errors. In one embodiment, the control form identifier 302 includes a machine-readable control code embedded therein. The process performs an optical recognition process on the control code as transmitted from the facsimile transmission or image of the control form. If the control code is not properly transmitted or decoded, the process determines that the received image lacks sufficient quality for processing and does not proceed to use or decode control parameters from the control form.

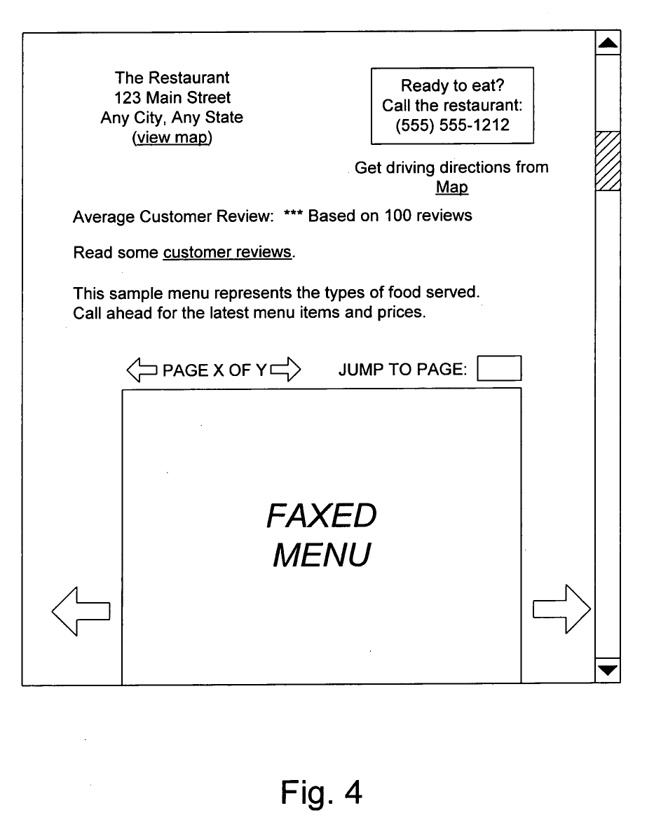

The optional control form identifier 302 can be used to distinguish the control form 300 from other faxed sheets, and/or to identify the type of control form being used. The optional content provider identifier 304 can be used to identify the originator-user of the facsimile transmission. Other techniques, such as caller ID techniques, automatic number identification (ANI) techniques, and indirect techniques can also be used to identify the calling number of the facsimile transmission, which can then be associated with an account, a public destination of the content, a database record, or the like. These techniques will be described in greater detail later following a description of the screenshot of FIG. 4. In addition, it should be noted that a single identifier can serve as both the optional control form identifier 302 and the optional content provider identifier 304.

In one embodiment, techniques such as bar codes or coded text strings are used to render the content provider identifier 304 deliberately unintelligible to a human reader. This can help to discourage false facsimile transmissions by unauthorized persons or pranksters. One-time-usable bar codes may also be used for this purpose.

The illustrated control form 300 includes an address box 306 that can include convenient information, such as the telephone number where the control form 300 is to be faxed. For example, the address box 306 can also include the originator's contact information, so that a customer service representative can easily contact the originator if a problem is detected. The illustrated control form 300 also includes examples of spaces for marks that can be used to provide information to the content association system 104 about the faxed content portion or portions. In one example, the control form 300 includes a designated area that the content association system recognizes as a content portion. For example, an area enclosed by a machine-readable border can be used. In another example, pages in the facsimile transmission other than the control form 300 correspond to one or more content portions.

The marks can be read by the content association system and used as metadata for a corresponding content portion. Metadata, as used herein, includes some indication of control parameters for content, such as processing of content, conversion of content from one format to another, placement of content within an electronic document, a temporal availability of the content, or the like. For example, information on the control form may indicate the type of information contained in the facsimile transmission (e.g., text, graphics, a logo, coupons or other promotions, temporal constraints such as expiration dates, length of time, etc.). These control parameters can be used to control extraction and interpretation the content, to determine how to present such content on one or more web pages, to initiate character recognition, to determine how long such content is to remain valid, and the like. For example, the marks can be used as control parameters for a computer program of the content association system 104 and can be used to control the branching of decisions. One convenient form of marks includes “fill-in” bubble marks that are read by optical mark recognition (OMR) techniques. In the illustrated control form 300, the corresponding human-readable information conveyed by a mark is included on the control form 300. However, it will be understood that the control form 300 can also correspond to an “answer sheet,” and that the corresponding information that is conveyed can be provided in a separate resource, such as a separate printed document. This can increase the amount of information provided per control form and decrease the amount of resources used in performing optical mark recognition (OMR) or in sending or storing a facsimile transmission.

The control form 300 can include optically-readable marks, characters, or other indicia, relating to type information specifying the type of content or information provided on or with the control form 300. One example of a type of content is whether the content portion corresponds to a temporary update 308. An example of an application of the temporary update 308 includes a list of items on sale, coupons, a temporary change in open hours, and the like. In another example, type information indicates that the content portion corresponds to a logo 310. In another example, type information indicates that the content portion is textual 312. This can be machine read by the content association system 104 as a control parameter to programmatically activate an optical character recognition (OCR) process.

In the illustrated embodiment, the control form 300 includes a control area for requesting a faxed preview 314. This permits the originator-user to instruct the content association system 104 to provide a preview of the update to the electronic document, such as web page email message, etc., before the content portion is made available, as described above.

Other types of information can be provided on the control form 300. In one example, the control form 300 includes one or more spaces for marks to indicate a business type of the originator entity. This information can be used to associate the web page with the content portion with the business type, such as in a “yellow pages” directory search.

Although the form shown in FIG. 3A supports the ability to specify a variety of different types of control information, a simpler form may alternatively be used. For instance, the control form 300 may consist of a bar code that specifies an identifier of the originator, and a content area for providing the content to be made available. Further, the control form may be provided with an control area for specifying a URI (Uniform Resource Identifier), or other address, at which the content is to be made available.

FIG. 3B illustrates another example of a control form 320. A barcode 322 illustrates an example of a machine-readable identifier for a user-originator of the facsimile transmission or other electronic transmission. The identifier can be associated with an account, a database record, a public destination such as a web site address for dissemination, an email recipient list, or the like. A control number field 324 can provide metadata or any indication of a control parameter regarding the content portion of the facsimile transmission. For example, in the context of a restaurant, the restaurant may have different menus for breakfast, lunch, and dinner, and may also have a drink menu. By filling in the appropriate bubbles, the content provider can indicate which portion of the menu is being updated. For example, by filling in the bubble for the 1, 2, 3, or 4 bubble, the originator-user can indicate that the content corresponds to a breakfast menu, a lunch menu, a dinner menu, or a drink menu, respectively. This advantageously permits the content association system 104 to generate content for an appropriate web page quickly and efficiently with little or no manual intervention. In another example, another field 326 can indicate whether the pages provided replace previous pages or are in addition to existing pages.

FIG. 3C illustrates an example of a form 340 without an identifier. For example, where an account, record, web site address, email list, etc., for an originator-user can be identified without an identifier on the form, such as, for example, by using caller ID, automatic number identification (ANI), transmitting subscriber identification (TSI), an IP address, a username and/or a password, or the like, the form 340 does not need to have an identifier. In the illustrated example of FIG. 3C, the form is used to upload coupons for a limited campaign period, such as for an after-holiday sale. For example, the originator-user can fill in a time using a number field 342, which can be read by OCR techniques, and the originator-user can fill in a bubble 344 for hours, days, weeks, months, and the like. Coupons can be attached 346 to the form 340. In another embodiment, a control form is provided without a corresponding content portion to provide control instructions for existing content, such as to delete or otherwise manipulate previously uploaded content. The existing content can be referenced by, for example, a web page address, a page number, a filename, bubbles for marks on a form corresponding to existing pages, or the like.

FIG. 4 illustrates an example of a screenshot of a web page generated by the content association system 104 in the context of a restaurant menu. For example, the web page can include the restaurant name and address, hyperlinks to maps and/or driving instructions, customer reviews, navigation buttons for menus of multiple pages, and the like. In one example, the content is made available in graphical form, and the content is also converted to text by an OCR process to allow an end-user to perform text searches on content. For example, a web page with hyperlinks to other web pages with matching content can be provided to a user at least partially in response to the entering of search terms in a text string.

Other Techniques for Identifying a Originator-User

Other techniques than an optically-recognized identifier, such as the content provider identifier 304 can be used. These techniques include caller ID techniques, automatic number identification (ANI) techniques, IP Addresses, and indirect techniques can also be used to identify the originator or sender of the facsimile transmission. In one embodiment, rather than identifying the originator-user, the public destination, such as a web page address, for the content of the electronic transmission is identified. It should be noted that in the illustrated techniques, a particular intended recipient (other than the content association system 104) does not have to be identified. The content is accessible by the general public.

The facsimile transmission or other electronic transmission received by the content association system 104 is associated with an electronic location for a publicly-accessible electronic repository, such as an address for a web site. For example, the originator-user of the facsimile transmission can be identified, and the corresponding publicly-accessible destination can be associated. For example, the content provider identifier 304 can correspond to an identifier for a restaurant, and a web address for the restaurant can be retrieved from a data store such as a database. In another example, the content is made available by the content association system 104 at the electronic location for the publicly-accessible electronic repository that is indicated on one or more control forms. In another example, the content is sent to email recipients on a corresponding list associated directly or indirectly with the originator-user.

Indirect methods for associating the publicly-accessible location can also be used. For example, FIG. 3C illustrates a control form without an identifier. A variety of indirect techniques can be used. For example, the content association system 104 can identify the calling phone number of the facsimile transmission via caller ID. Automated number identification (ANI) can also be used, and unlike caller ID, cannot be blocked. Of course, it will be understood that calling phone number retrieval techniques will vary depending on the phone standards used, which typically varies from country to country.

Another indirect method is to “pool” one or more phone numbers for the content association system 104. For example, an originator-user can be allotted a predetermined timeslot, such as a 24-hour period, to fax the relevant forms to a particular pooled phone number. A fax received during the timeslot at that phone number is automatically associated directly or indirectly with the originator-user, such as email lists, accounts, web addresses, database records, or the like. Other timeslots can be allotted to other entities. In one embodiment, after the lapse of a timeslot allotted to an entity, the pooled phone number is temporarily disabled or removed from the pool for a predetermined time period, such as a week, and then reactivated for another timeslot. Where a content association system 104 handles a plurality of different phone numbers, techniques such as the dialed number information service (DNIS) can be used to distinguish among the various phone numbers dialed.

Other Techniques for Providing Content

As illustrated in the foregoing, one distinction between embodiments of the invention and conventional communications techniques is that an intended recipient (other than the content association system 104) does not have to be identified. Rather, the content can be made publicly accessible, without, for example, restriction via password protection for the end-user or the end-user's client address, such as IP address. This relieves the content provider of having to maintain a list or even know the parties interested in viewing the content. For example, end-users can sign up to an anonymous list to receive updates to specified categories, such as for coupons, and this list can be hidden from the originator-user.

In addition, specific members of the general public may request to be notified of certain events, and the content association system 104 can facilitate these requests. These activities can be transparent to the originator-user providing the content to be made publicly available, which enhances the privacy of the members of the general public who desire to receive notifications and relieves the burden on the originator-user of maintaining a customer list.

For example, these notifications can be provided by the content association system 104 in an automated email notification or “email alert” to the requesting member of the public. The content association system 104 can provide the email alert at least partially in response to one or more activities, such as, but not limited to, updated content on a user's watch list or list of favorite places, periodic searches for new content matching with search terms such as “coupon,” and the like. The email alert can include a portion of the content, such as a portion of text recognized from the facsimile transmission and can also include an address of the content in the electronic repository, such as a hyperlink to the repository or web page.

In another example, the content association system 104 can provide a least a portion of the content for an RSS feed or some other syndication process. For example, a selected portion of relatively recently added content can be converted to text using an OCR process and provided to a server that generates an RSS feed. In another example, the content association system 104 can provide a portion of the content, converted to text, to a wireless email device using a wireless communication protocol or to a cell phone using a short message service (SMS) message.

The foregoing description is intended to be illustrative, and not limiting. Various modifications and applications may occur to those skilled in the art without departing from the true spirit and scope of the invention, which is defined by the appended claims.

What is claimed is:

1. A computer-implemented method of providing content to a web site, the method comprising:
receiving an electronic transmission of an image of a physical form, said form comprising a content portion that comprises content to be made available at the web site, and including a machine-readable control portion that includes control information associated with said content;
storing a digital representation of the electronic transmission in computer storage;
processing the digital representation of the electronic transmission to extract the content and the associated control information; and
programmatically making the content available for end-user access at the web site in accordance with the control information, where the control information controls a graphical manipulation of the content as displayed for the end-user.

2. The method of claim 1, wherein the electronic transmission corresponds to a facsimile transmission.

3. The method of claim 1, wherein the physical form is scanned into electronic form, and the electronic transmission corresponds to a network transmission of the electronic form.

4. The method of claim 1, wherein the web page corresponds to an HTML document.

5. The method of claim 1, wherein the web page corresponds to a file in a word processing document format or in a platform-independent file format.

6. The method of claim 1, wherein the control portion includes a bar code representation of a unique identifier, and the method further comprises using the unique identifier to select a web page to which the content is to be made available.

7. The method of claim 6, wherein the electronic transmission is a facsimile transmission, further comprising responding to the facsimile transmission by sending, to an originator-user of the facsimile transmission, a confirmation facsimile transmission that depicts the web page with the content made available thereon.

8. The method of claim 1, wherein the control portion includes type information that specifies a type of content included on the form.

9. The method of claim 8, wherein the type information indicates whether the content is textual.

10. The method of claim 8, further comprising using the type information to select a portion of a web page to which the content is to be made available.

11. The method of claim 1, wherein the control portion includes type information that specifies a type of content included with the facsimile transmission.

12. A computer-implemented method of modifying displayable content, the method comprising:
receiving an electronic transmission of an image of a physical form, the form including a machine-readable control portion;
storing a digital representation of the electronic transmission in an addressable storage medium;
processing the digital representation of the electronic transmission to extract the control information;
associating the extracted control information with the displayable content; and
programmatically altering the displayable content according to the control information.

13. The method of claim 12, further comprising providing the displayable content to a recipient-user without a request from the recipient-user.

14. The method of claim 13, further comprising associating the control information with an email list and using the email list to send the displayable content to the recipient-user.

15. The method of claim 12, further comprising providing the displayable content to a recipient-user at least partially in response to a request from the recipient-user for a corresponding electronic document.

16. A computer-implemented method, the method comprising:
receiving a facsimile transmission in one or more computer systems;
processing at least a portion of the facsimile transmission to create a displayable content item; and
associating the displayable content item directly or indirectly with a resource address for an electronic document such that the displayable content item is publicly accessible in an unrestricted manner without restriction by client address or by password.

17. The method of claim 16, wherein associating further comprises directly associating the displayable content item with the resource address, where the resource address is selected to correspond to an originator-user of the facsimile transmission.

18. The method of claim 16, wherein associating further comprises associating with a selected database record, which is associated with the resource address, where the resource address corresponds to an originator-user of the facsimile transmission.

19. The method of claim 16, wherein the facsimile transmission also includes a machine-readable control portion, where the machine-readable control portion includes at least an identifier associated at least indirectly with an originator of the facsimile transmission, the method further comprising:
translating the machine-readable control portion of the facsimile transmission with computer-implemented optical recognition to read the identifier for the content provider; and
determining a corresponding account for the originator from the identifier.

20. The method of claim 16, further comprising determining an account for an originator of the facsimile transmission using a feature from a telephone service.

21. The method of claim 16, further comprising determining an account for an originator-user of the facsimile transmission from transmitting subscriber identification (TSI) information of the facsimile transmission.

22. The method of claim 16, further comprising determining an account for an originator of the facsimile transmission at least partially based on a timeslot in which the facsimile transmission is received.

23. The method of claim 16, further comprising associating the displayable content item with one or more database objects, which are also associated with the resource address.

24. The method of claim 23, further comprising:
performing an optical character recognition (OCR) process on at least a portion of the content portion or the displayable content item;
storing text from the OCR process as a database object; and
associating the database object corresponding to the stored text with the displayable content item.

25. The method of claim 24, further comprising:
electronically receiving a text string from an end user;
using the text string to perform an electronic search on stored text in database objects; and
providing one or more corresponding displayable content items or resource addresses corresponding to the one or more displayable content items upon a match in the search.

26. The method of claim 16, further comprising determining that the content portion corresponds to a half-tone image, and wherein processing further comprises converting the half-tone image to a grayscale image for the displayable content item.

27. The method of claim 16, wherein the facsimile transmission also includes a machine-readable control portion, further comprising translating one or more machine-readable marks in the machine-readable control portion into one or more control parameters.

28. The method of claim 27, wherein the displayable content item is associated with the resource address according to the one or more control parameters.

29. The method of claim 27, wherein at least one of the one or more control parameters corresponds to an instruction for text conversion and wherein processing corresponds to optical character recognition.

30. The method of claim 27, wherein at least one of the one or more control parameters corresponds to an instruction for scaling and wherein processing corresponds to scaling of the displayable content item.

31. The method of claim 27, wherein at least one of the one or more control parameters corresponds to an indication of a color and wherein processing comprises specifying one or more pixels of the displayable content item to the color.

32. The method of claim 27, wherein at least one of the one or more control parameters corresponds to a temporal constraint, and further comprising discontinuing the availability of the displayable content item beyond the temporal constraint.

33. The method of claim 16, further comprising:
providing an originator-user of the facsimile transmission with a preview of the displayable content item before the displayable content item is made publicly accessible;
requesting authorization from the originator-user to proceed with associating the displayable content item; and
associating the displayable content item after determining an indication of verification.

34. The method of claim 33, wherein determining the indication of verification comprises an expiration of a passage of time without receiving instructions not to make publicly available.

35. The method of claim 16, wherein the displayable content item corresponds to at least a portion of a static web page, and wherein associating the displayable content item further comprises making the static web page available at a uniform resource identifier (URI).

36. The method of claim 16, further comprising dynamically generating a web page including the displayable content item in response to receiving a request for the web page.

37. The method of claim 16, further comprising:
maintaining a watch list of one or more resource addresses;
determining that content for one or more resource addresses in the watch list has changed; and
programmatically sending a message to an email address associated with the watch list at least partially in response to the determination.

38. The method of claim 37, further comprising including one or more hyperlinks corresponding to the one or more resource address in the message sent to the email address.

39. A computer-implemented method, the method comprising:
receiving a facsimile transmission in one or more computer systems of a form, where the form includes a content portion corresponding to content to be provided;
automatically identifying a source of the facsimile transmission using at least one of a telephone service feature or a transmitting subscriber identification (TSI) number;
processing at least a portion of the facsimile transmission to create a displayable content item; and
using the identified source to associate the displayable content item with a database record.

40. The method of claim 39, further comprising providing the displayable content item to a recipient-user without receiving a request from the recipient-user.

41. The method of claim 39, further comprising associating the source with an email list, and automatically sending an electronic message including the displayable content item to recipient-users of the email list.

42. The method of claim 39, further comprising using the identified source to associate the displayable content item directly or indirectly with a resource address in an information space for an electronic document comprising the displayable content item.

43. The method of claim 42, wherein the resource address is a uniform resource identifier (URI).

44. The method of claim 42, wherein the information space corresponds to the Internet.
